(19) United States
(12) Patent Application Publication
(10) Pub. No.: US 2024/0428149 A1
(43) Pub. Date: Dec. 26, 2024

(54) SYSTEM AND METHOD FOR ASSISTING IN LAWN MANAGEMENT

(71) Applicant: KAWASAKI MOTORS, LTD., Akashi-shi (JP)

(72) Inventors: Hiroyuki KATAOKA, Akashi-shi (JP); Hirokazu MORITA, Akashi-shi (JP); Tomotaka NAKAGAWA, Akashi-shi (JP)

(21) Appl. No.: 18/339,618

(22) Filed: Jun. 22, 2023

(51) Int. Cl. G06Q 10/0631

(52) U.S. Cl. CPC G06Q 10/0631

(57) ABSTRACT

A lawn management assistance system 1 includes a communicator 32 and a processor 31. The communicator 32 receives positional information of a lawn mower 10 detected by a position sensor 16 installed at the lawn mower 10 and receives condition information of a lawn detected by a condition sensor 17 installed at the lawn mower 10. The processor 31 analyzes the condition information per piece of the positional information based on information received by the communicator 32 and generates and outputs improvement information indicating a method for improvement of condition of the lawn per piece of the positional information.

### TECHNICAL FIELD

The present application relates to a system and a method for assisting in lawn management.

### BACKGROUND ART

PTL 1 is U.S. patent publication No. 2018/0213731.

PTL 1 discloses a system for detecting condition of a lawn by installing a sensor on a robotic lawn mower.

### SUMMARY OF THE INVENTION

The system of PTL 1 detects condition of a lawn. However, in order to improve the detected condition of the lawn, a manager of the lawn should have specialized knowledge.

The present application is made in view of the situation described above, and its main purpose is to provide a system for assisting in lawn management.

The problem to be solved by the present application is as described above. The means to solve this problem and the effects thereof will be described below.

A first aspect of the present application provides a lawn management assistance system with a configuration described below. That is, the lawn management assistance system includes a communicator and a processor. The communicator receives positional information of a lawn mower detected by a position sensor installed at the lawn mower and receives condition information of a lawn detected by a condition sensor installed at the lawn mower. The processor analyzes the condition information per piece of the positional information based on information received by the communicator and generates and outputs improvement information indicating a method for improvement of condition of the lawn per piece of the positional information.

A second aspect of the present application provides a lawn management assistance method as described below. That is, the lawn management assistance method includes receiving positional information of a lawn mower detected by a position sensor installed at the lawn mower. The lawn management assistance method includes receiving condition information of a lawn detected by a condition sensor installed at the lawn mower. The lawn management assistance method includes analyzing the condition information per piece of the positional information and generating and outputting improvement information indicating a method for improvement of condition of the lawn per piece of the positional information.

### Effects of the Invention

According to the present application, after detecting the condition of the lawn, the improvement information for improving the condition of the lawn is presented to a user. This makes it easier for the user to improve the condition of the lawn, so that the management of the lawn can be simplified.

### BRIEF DESCRIPTION OF THE DRAWINGS

FIG. 1 is a block diagram of a lawn management assistance system.

FIG. 2 is a sequence diagram of a lawn management assistance system.

FIG. 3 is a table showing a first example of improvement information generated based on condition information.

FIG. 4 is a table showing a second example of improvement information generated based on condition information.

FIG. 5 is a table showing a third example of improvement information generated based on condition information.

FIG. 6 is a table showing a fourth example of improvement information generated based on condition information.

FIG. 7 is a drawing showing an example of a screen presenting improvement information.

FIG. 8 is a flowchart showing a process for modifying improvement information based on additional information.

FIG. 9 is a flowchart showing a process related to a sorting rule of additional information according to user categories.

FIG. 10 is a flowchart showing a process for suggesting a date and time for performing maintenance.

### EMBODIMENT FOR CARRYING OUT THE INVENTION

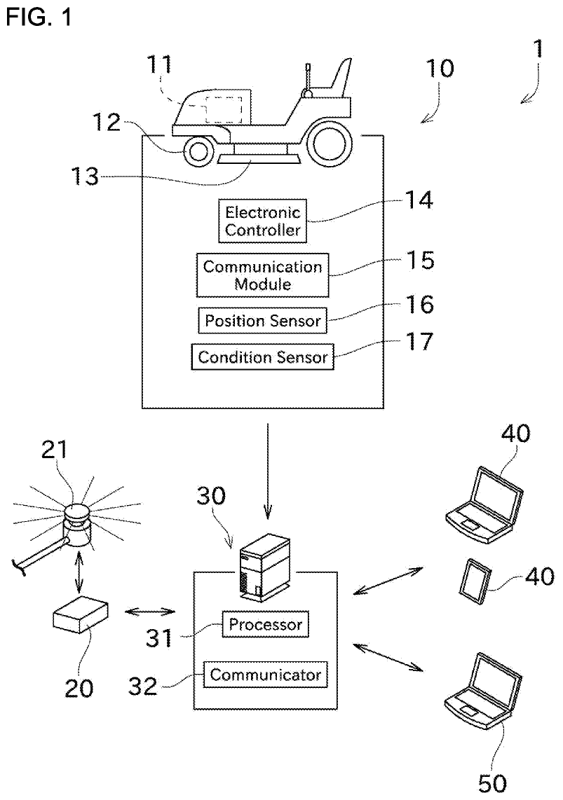

An embodiment of the present application will be described below with reference to the drawings First, a configuration of a lawn management assistance system 1 will be described with reference to FIG. 1.

The lawn management assistance system 1 is a system that presents information to a user to assist them in management of a lawn. In the following description, a user of the lawn management assistance system 1 will be referred to simply as the user. The users can be divided into two user categories: owners of lawns and contractors who provide a lawn mowing service upon request from the owner. The contractors may provide lawn maintenance instead of or in addition to lawn mowing. The users are not limited to the owners or the contractors. For example, the users may include brokers that receive requests from the owners and select the contractors.

Lawns to be mowed exist at various locations. For example, a lawn exists in a residential yard, an institutional open space, a park, or a golf course. Depending on a lawn to be mowed, the condition of the lawn, especially the difference of the height within the lawn varies. For example, the lawn may include a raised area around a tree, a slope for drainage, an undulation made for landscaping, and a natural undulation. Therefore, the heights of areas of the lawn are different from each other.

In addition, the lawn is an area where grass under cultivation is growing. In contrast, the grassland is an area that is mainly composed of weeds. Besides, as for the lawn, landscaping by the grass is important. On the other hand, landscaping is not so important for the grassland. Therefore, lawn mowing should be done in such a way that the condition of the grass is kept under the cultivation and that the lawn is landscaped. In other words, the purpose of lawn mowing is not to remove grass but to conduct maintenance for the grass and to landscape the lawn. In contrast, since the purpose of mere cutting the grass is removal of the weeds only, landscaping or condition of the grass is not considered and maintenance is not required . . . .

As shown in FIG. 1, the lawn management assistance system 1 includes a lawn mower 10, a watering controller 20, a server 30, an owner terminal 40, and a contractor terminal 50. The lawn management assistance system 1 should include at least the server 30, but the other apparatuses need not to be included.

The lawn mower 10 mows a lawn. Lawn mowing is an act of cutting grass growing on the lawn. Since the lawn mower 10 is self-propelled, it includes a configuration to propel itself. Specifically, the lawn mower 10 includes a drive source 11 and wheels 12. The drive source 11 is an engine. The drive source 11 generates power by burning a fuel. The power generated by the drive source 11 is transmitted to the wheels 12. In this manner, the lawn mower 10 moves. The engine may be, for example, a gasoline engine or a diesel engine. The drive source 11 may be an electric motor or may be comprised of both an engine and an electric motor.

The lawn mower 10 includes a steering lever and a seat. An operator sits on the seat of the seat of the lawn mower 10 and operates the steering lever. The lawn mower 10 may be configured in such a way that the operator stands on the lawn mower 10. The lawn mower 10 may be include a steering wheel instead of the steering lever. The lawn mower 10 may be configured in such a way that the operator pushes it to move it instead of configured as self-propelled. In other words, the drive source 11 for travelling is not an essential component and may be omitted. The lawn mower 10 may be configured to be remotely operated by the operator. The lawn mower 10 may be configured to be autonomous so that it does not require operation by the operator.

The lawn mower 10 includes a mower blade unit 13. The mower blade unit 13 includes a rotary mower blade. The power generated by the drive source 11 is transmitted to the mower blade unit 13. In this manner, the mower blade of the mower blade unit 13 rotates and cuts the grass.

The lawn mower 10 includes an electronic controller 14. The electronic controller 14 an electronic apparatus that controls components such as the drive source 11. Specifically, the electronic controller 14 is a microcomputer that includes a CPU, a main memory, and storage. The CPU loads a program and control data stored in the storage into the main memory and executes it. In this manner, the electronic controller 14 performs various controls concerning the lawn mower 10. For example, the electronic controller 14 performs a drive control. The drive control is a control for operating the drive source 11 and may be, for example, a control related to fuel injection.

The lawn mower 10 includes a communication module 15. The communication module 15 may be, for example, a TCU. TCU stands for Telematics Control Unit. The communication module 15 includes a communication circuit. The communication circuit communicates via a mobile network using an internal antenna or an external antenna. In other words, the communication module 15 can directly connect to the Internet without a router or a smartphone. The communication module 15 transmits information to the server 30 according to a command from the electronic controller 14.

The communication module 15 is not limited to the TCU. For example, the communication module 15 may be a wireless communication module capable of conducting proximity wireless communication. In this case, the communication module 15 can communicate with a smartphone via proximity wireless communication. The communication module 15 may also be configured to capable of connecting to the Internet via a smartphone. Alternatively, the communication module 15 may be a wired communication module that can connect to a PC via wired communication.

The lawn mower 10 includes a position sensor 16 and a condition sensor 17. The position sensor 16 and the condition sensor 17 are installed at the lawn mower 10 and move integrally with the lawn mower 10.

The position sensor 16 is a GNSS sensor and includes a GNSS antenna and a GNSS receiver. The GNSS receiver calculates the latitude and longitude of the position of the lawn mower 10 based on signals received by the GNSS antenna from satellites. In the following description, the information that indicates the latitude and longitude of the position of the lawn mower 10 will be referred to as positional information. The position sensor 16 outputs the positional information of the lawn mower 10 to the electronic controller 14.

The condition sensor 17 is a sensor that detects condition information that indicates condition of a lawn close to the lawn mower 10. The condition of the lawn includes condition of soil, condition of grass, or condition of weeds in the lawn. Plants that are meant to be cared in lawn mowing are grass and plants that are not meant to be cared in lawn mowing are weeds. The weeds are plants that are not planted by the owner and is subject to control (for example, removal and prevention). The condition sensor 17 is, for example, a camera, an detection sensor, a torque sensor, or a soil sensor. The camera takes pictures of the lawn and produces images of the soil, the grass, and the weeds. The detection sensor detects surroundings of the lawn mower 10. The detection sensor is, for example, a LiDAR, an ultrasonic sensor, a radar, or a contact sensor. The LiDAR, the ultrasonic sensor, and the radar detect the surroundings by emitting electromagnetic waves or sound waves and analyzing reflected waves. In this manner, height, shape, density, distribution and the like of the grass close to the lawn mower 10 are detected. The contact sensor is a sensor that receives force from the grass and is displaced when it comes into contact with the grass. The contact sensor detects, for example, whether the height of the grass is higher or lower than a predetermined value. The torque sensor is, for example, a strain gauge installed at a drive shaft of the mower blade unit 13. The torque sensor detects torque in the drive shaft of the mower blade unit 13. The soil sensor is a sensor that detects moisture content or hardness of the soil. The condition sensor 17 outputs the detected condition information of the lawn to the electronic controller 14.

As described below, the condition information detected by the condition sensor 17 is linked to the positional information of the lawn mower 10. If the condition sensor 17 detects a lawn located far from the lawn mower 10, the accuracy of the correspondence between the positional information and the condition information will be lower. Therefore, it is preferable that the condition information detected by the condition sensor 17 is information of the lawn closer to the current position of the lawn mower 10. For example, if the condition sensor 17 is a camera, it is preferable to point the camera downward instead of pointing the camera straightforwardly to the front. This makes the position of the lawn mower 10 and the detected position as the condition information less likely to separate, so that the accuracy of the correspondence between the positional information and the condition information becomes high. In the case that the condition sensor 17 detects the condition of the lawn 10 meters ahead of the lawn mower 10, the positional information may be, for example, modified to be 10 meters ahead of the original.

The server 30 includes a processor 31, which is a computer that includes a CPU, a main memory, and storage. The CPU loads a program and control data stored in the storage into the main memory and executes it. In this manner, the processor 31 performs a control on the processing of information about the lawn mower 10. The server 30 also includes a communicator 32 that connects to the Internet via a router or the like. The communicator 32 is a wired communication module and amplifies and converts signals for communication. The communicator 32 may be a wireless communication module. The server 30 may be comprised of a single hardware unit. Alternatively, multiple hardware units may work together to perform the functions of the server 30.

More than one water sprinkler 21 is arranged in the lawn. The water sprinklers 21 are controlled by the watering controller 20. The water sprinklers 21 are supplied with water via hoses. The water sprinkler 21 includes a jet for spraying water. The water sprinkler 21 sprays water from the jet in response to a control command from the watering controller 20. The watering controller 20 is a microcomputer that includes a CPU, a main memory, and storage. The watering controller 20 make settings for the amount of water to be sprinkled per time, the frequency of sprinkling, and the like, and outputs control commands to the water sprinkler 21 according to the settings. The watering controller 20 also includes a wireless or wired communication module and can communicate with the server 30. Instead of the automatic watering configuration using the water sprinklers 21, the lawn may be manually watered using a hose or other watering supplies.

The owner terminal 40 is a computer used by the owner. The contractor terminal 50 is a computer used by the contractor. Each of the owner terminal 40 and the contractor terminal 50 includes a CPU, a main memory, storage, and a display. The owner terminal 40 and the contractor terminal 50 are PCs, smartphones, or tablet devices. The owner terminal 40 and the contractor terminal 50 may be general-purpose products with other uses or specialized products used only for the lawn management assistance system 1.

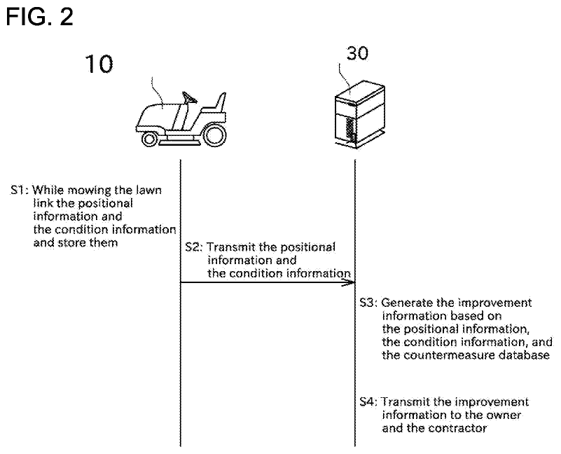

Then, with reference to FIG. 2, the basic processes performed by the lawn management assistance system 1 will be described below.

The lawn mower 10 detects the positional information by using the position sensor 16 while mowing the lawn. The lawn mower 10 detects the condition information by using the condition sensor 17 while mowing the lawn. The electronic controller 14 links the positional information and the condition information and stores them (sequence number S1). In the present embodiment, the lawn mower 10 detects the positional information and the condition information while mowing the lawn. Alternatively, the lawn mower 10 may detect the positional information and the condition information without mowing the lawn.

Then, the electronic controller 14 transmits the positional information and the condition information to the server 30 using the communication module 15 (sequence number S2). In the present embodiment, the electronic controller 14 transmits the positional information and the condition information to the server 30 after lawn mowing is finished. Alternatively, the electronic controller 14 may transmit the positional information and the condition information to the server 30 in real time while mowing the lawn.

Then, the server 30 generates improvement information per piece of the positional information based on the positional information, the condition information, and a countermeasure database (sequence number S3). The countermeasure database is a database for generating the improvement information based on the condition information. The countermeasure database may be stored on the server 30 or other hardware. The countermeasure database will be described in detail below. The improvement information is information for improving the condition of the lawn. As described above, the condition of the lawn includes the condition of the soil, the grass, or the weeds. Therefore, information for improving the condition of the lawn includes information for improving the condition of the soil, information for improving the condition of the grass, and information for controlling weeds. Specific examples of the improvement information will be described later.

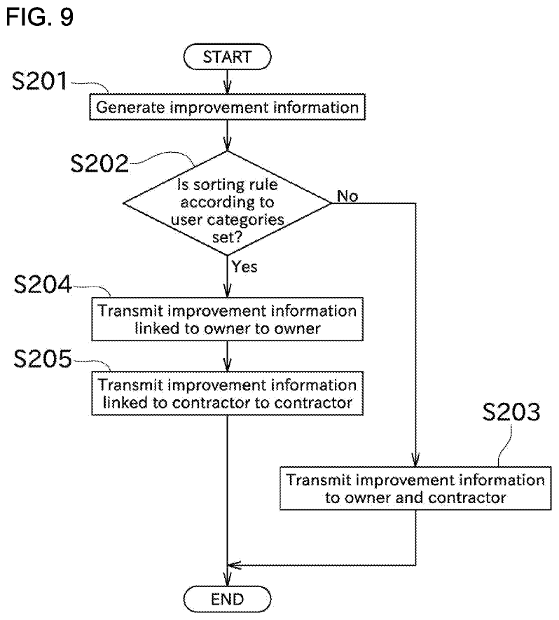

The server 30 then transmits the generated improvement information to the owner and the contractor (sequence number S4). The server 30 transmits the improvement information when generated it regardless of whether the owner or the contractor requests. As shown in FIG. 9 and described later, the improvement information transmitted to the owner and the improvement information transmitted to the contractor may be different. The server 30 may store the improvement information, wait until the owner or the contractor requests for, and transmit the improvement information upon the request. When transmitting the improvement information to the owner, the server 30 transmits the improvement information to the owner terminal 40. When transmitting the improvement information to the contractor, the server 30 transmits the improvement information to the contractor terminal 50. The transmission may be performed using an e-mail, a notification function of a specialized application, or the like. The owner terminal 40 or the contractor terminal 50 shows the received improvement information in a text formant or a format including a drawing on a display. The improvement information may be notified by a sound instead of or in addition to being shown on a display.

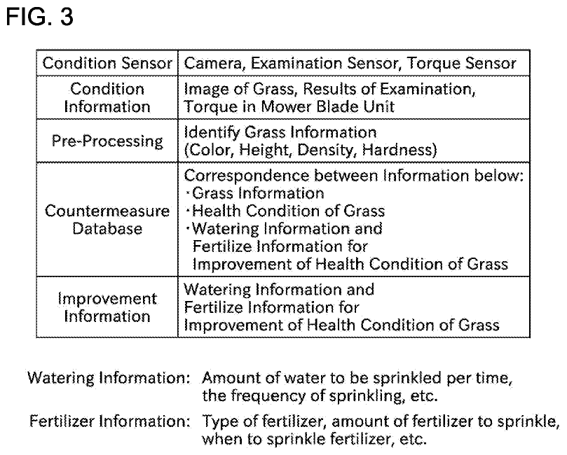

With reference to FIG. 3 through FIG. 6, examples of how to generate the improvement information based on the condition information and the countermeasure database will be described below.

First, with reference to FIG. 3, a process of generating the improvement information for improvement of the health condition of the grass based on grass information will be described below.

In an example shown in FIG. 3, a camera, an detection sensor, or a torque sensor is used as the condition sensor 17. In the case where the condition sensor 17 is a camera, an image of the grass generated by the camera corresponds to the condition information. In the case where the condition sensor 17 is an detection sensor, results of the detection on the grass corresponds to the condition information. In the case where the condition sensor 17 is a torque sensor, torque in the mower blade unit 13 when cutting the grass corresponds to the condition information.

The processor 31 performs pre-processing on the condition information. The pre-processing is a process performed in order to analyze the condition information to obtain detailed information. In the case where the condition information is an image of the grass, the processor 31 analyzes the image of the grass to identify color, height, or density of the grass. The density of the grass is the amount of the grass present per predefined unit of area. In the case where the condition information is results of the detection on the grass, the processor 31 analyzes the results of the detection on the grass to identify height or density of the grass. In the case where the condition information is torque in the mower blade unit 13, the processor 31 identifies density or hardness of the grass based on the torque. In the following description, various data on the grass obtained by performing the pre-processing will be referred to as grass information.

The processor 31 generates the improvement information based on the grass information and the countermeasure database. The countermeasure database is a database where the grass information, the health condition of the grass, and watering information and fertilizer information for improvement of the health condition of the grass linked to each other are stored. The watering information is information that indicates the amount of water sprinkled per time, the frequency of watering, or the like. The fertilizer information is information that indicates the type of fertilizer, the amount of fertilizer to sprinkle, when to sprinkle fertilizer, or the like.

The grass information described above is closely related to the health condition of the grass. For example, when the grass is in good health, the grass tends to be greener, taller, and harder and the density of the grass tends to be higher. Therefore, by obtaining sample data of the grass in various condition and analyzing the relationship between the grass information and the health condition of the grass, the correspondence between the grass information and the health condition of the grass can be obtained.

The grass information described above is also closely related to the watering information and the fertilizer information for improvement of the health condition of the grass. For example, if water is inadequate, the color, the height, the density, or the hardness of the grass may be in a state that is unique to the condition with a lack of water. Or, if fertilizer is inadequate, the color, the height, the density, or the hardness of the grass may be in another state that is unique to the condition with a lack of fertilizer. Therefore, by obtaining sample data of the grass in various condition and analyzing the grass information as well as the watering information and the fertilize information corresponding to the grass or analyzing the change in the grass information when the grass is watered or fertilized differently, the correspondence between the grass information and the watering information and the fertilize information for improvement of the health condition of the grass can be obtained. Based on the above-mentioned two correspondences, the countermeasure database where the grass information, the health condition of the grass, and the watering information and the fertilizer information for improvement of the health condition of the grass linked to each other are stored can be built. The countermeasure database is preliminarily built and stored on the server 30 or the like.

The processor 31 can identify the health condition of the grass and the watering information and the fertilizer information for improvement the health condition of the grass by comparing the grass information obtained by performing the pre-processing to the countermeasure database. The processor 31 outputs the watering information and the fertilizer information for improvement of the health condition of the grass as the improvement information. Although the health condition of the grass is not included in the improvement information, it is useful information for the user. Therefore, the processor 31 may output the health condition of the grass in addition to the improvement information.

The grass information is obtained for each position in the lawn. Therefore, the processor 31 generates the improvement information for each position in the lawn. For example, the processor 31 divides the lawn into more than one area and transmits the improvement information per area to the owner or the contractor.

In the case where the server 30 and the watering controller 20 can communicate with each other, the server 30 may receive watering settings from the watering controller 20. The watering settings are settings made for each water sprinkler 21 that indicate the amount of water to be sprinkled per time, the frequency of sprinkling, and the like. The server 30 may refer to the positions of the water sprinklers 21 and the watering settings for each water sprinkler 21 and compare them to the watering information, i.e. the improvement information. The server 30 may calculate a correction value for the watering settings based on results of the comparison. The server 30 may generate a control command based on the calculated correction value and transmit it to the watering controller 20 to revise the watering settings. In this case, the correction value of for the watering settings or the control command corresponds to the improvement information. Also, in the case where the lawn is watered using a hose or other watering supplies, the server 30 may send a message indicating when to water the lawn to the owner terminal 40 or the contractor terminal 50. In this case, the message sent to the owner terminal 40 or the contractor terminal 50 corresponds to the improvement information.

With respect to the example shown in FIG. 3, FIG. 3 shows multiple condition sensor 17, multiple pieces of the condition information, and multiple pieces of the improvement information. However, at least one of the condition sensors 17 may be omitted, at least one piece of the condition information may be omitted, and at least one piece of the improvement information may be omitted. Another condition sensor 17, another piece of the condition information or another piece of the improvement information not shown in FIG. 3 may be employed.

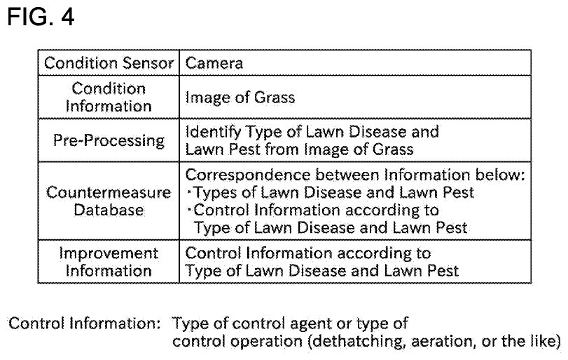

Then, with reference to FIG. 4, a process of generating the improvement information for controlling lawn diseases and lawn pests based on an image of the grass will be described below.

In an example shown in FIG. 4, a camera is used as the condition sensor 17. Since the condition sensor 17 is a camera, an image of the grass generated by the camera corresponds to the condition information.

A process of identifying a lawn disease and a lawn pest based on the image of the grass corresponds to a pre-processing for the example shown in FIG. 4. If the grass is diseased, the color of the grass may change or variation in the density of the grass may occur depending on the type of the disease. If the grass is infested with a pest, there may be insect holes in the grass or variation in the density of the grass may occur depending on the type of the pest. It is also possible that the pest may be captured in the image of the grass. As described above, the image of the grass is closely related to the lawn diseases and the lawn pests. Therefore, by obtaining and analyzing sample data of the grass diseased or infested with pests, the correspondence between the image of the grass and the types of the lawn diseases and the lawn pests can be obtained. This correspondence is preliminarily obtained and stored on the server 30 or the like. Thus, the processor 31 can identify the types of the lawn disease and the lawn pest by comparing the image of the grass to the correspondence.

The countermeasure database in the example shown in FIG. 4 is a database where the types of the lawn diseases and the lawn pests and control information according to the types of the lawn diseases and the lawn pests linked to each other are stored. The control information is information for preventing or removing the disease and the pest. Specifically, the control information indicates the types of control agents or the types of control operations. The control operation is, for example, a dethatching or an aeration. The dethatching is an operation of removing lawn thatch. The accumulation of the lawn thatch may be caused by grass clippings or dead leaves. The lawn thatch can be a breeding ground for the pests, so depending on the type of the pests, the dethatching can control the pests. The aeration is an operation of improving the aeration and drainage performance of the soil by performing root cutting to the grass. The aeration promotes the growth of the grass. The aeration also improves the drainage performance of the soil so that the grass can be kept in good health. As a result, the lawn diseases may be prevented or cured. The correspondence between the types of the lawn diseases and the lawn pests and the control information according to the types of the lawn diseases and the lawn pests has already been reliably established. Therefore, by referring to and extracting necessary information from literatures or the like, the countermeasure database where the types of the lawn diseases and the lawn pests and the control information according to the types of the lawn diseases and the lawn pests linked to each other are stored can be built. The countermeasure database is preliminarily built and stored on the server 30 or the like.

The processor 31 can identify the control information according to the types of the lawn disease and the lawn pest by comparing the types of the lawn disease and the lawn pest obtained by performing the pre-processing to the countermeasure database. The processor 31 outputs the control information according to the types of the lawn disease and the lawn pest as the improvement information. Although the types of the lawn disease and the lawn pest is not included in the improvement information, it is useful information for the user. Therefore, the processor 31 may output the types of the lawn diseases and the lawn pest in addition to the improvement information.

Although only the types of the disease and the pest is identified in the example shown in FIG. 4, the extent of the lawn disease or the number of the pests may be identified instead of or in addition to the types of them. In other words, the processor 31 analyzes the image of the grass to identify how much area of the grass is diseased or infested by the pests, and identifies the extent of the disease or the number of the pests based on the area. It is preferable that the improvement information in this case also includes the amount of the control agent to sprinkle.

In the example shown in FIG. 4, the improvement information is the control information according to the types of the lawn disease and the lawn pest. Alternatively, the improvement information may be the control information according to the type of at least one of the lawn disease or the lawn pest.

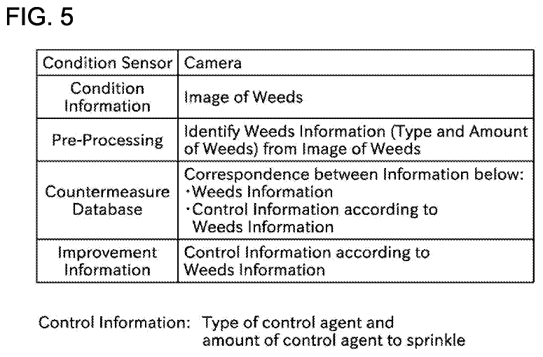

With reference to FIG. 5, a process of generating the improvement information for controlling the weeds based on an image of the grass will be described below.

In an example shown in FIG. 5, a camera is used as the condition sensor 17. Since the condition sensor 17 is a camera, an image of the weeds generated by the camera corresponds to the condition information. Since it is difficult to select and capture only the weeds, the image includes a mixture of the grass and the weeds.

A process of extracting the weeds from the image and identifying weeds information corresponds to a pre-processing for the example shown in FIG. 5. The weeds information indicates the type and the amount of the weeds. The processor 31 removes the grass from the image generated by the camera. Since the type of the grass is previously known, preliminarily storing an image of the grass on the server 30 allows the removal of the grass from the image by a matching processing or the like. The plants still included in the image after removing the grass corresponds to the weeds. Since the types of the weeds that grow in the lawn are limited, storing images of all types of the weeds on the server 30 allows the type of the weeds to be identified from the image by a matching processing or the like. The amount of the weeds can also be identified based on the area of the lawn where the weeds are determined to be present or the like. In the manner as described above, the processor 31 identifies the type and the amount of the weeds based on the image.

The countermeasure database in the example shown in FIG. 5 is a database where the weeds information and control information according to the weeds information linked to each other are stored. The control information is information for preventing or removing the weeds. Specifically, the control information indicates the type of the control agents according to the type of the weeds, the amount of the control agent to sprinkle according to the amount of the weeds, and control operations according to the types of the weeds. The control operation is, for example, increasing frequency of lawn mowing that allows the density of the grass to be increased and thus inhibits the weeds from growing. Alternatively, the control operation may be keeping the grass long to inhibit the short weeds from growing. The correspondence between the weeds information and the control information according to the weeds information has already been reliably established. Therefore, by referring to and extracting necessary information from literatures or the like, the countermeasure database where the weeds information and the control information according to the weeds information linked to each other are stored can be built. The countermeasure database is preliminarily built and stored on the server 30 or the like.

The processor 31 can identify the control information according to the weeds information by comparing the weeds information obtained by performing the pre-processing to the countermeasure database. The processor 31 outputs the control information according to the weeds information as the improvement information. Although the weeds information is not included in the improvement information, it is useful information for the user. Therefore, the processor 31 may output the weeds information in addition to the improvement information.

In the example shown in FIG. 5, the type and the amount of the weeds are identified in the pre-processing. Alternatively, only one of the type of the weeds or the amount of the weeds may be identified in the pre-processing. In the example shown in FIG. 5, the control information includes the information about the control agent and the information about the control operation. Alternatively, the control information may include only one of the information about the control agent and the information about the control operation.

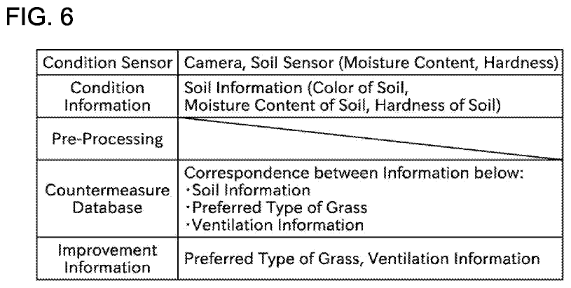

With reference to FIG. 6, a process of generating information about preferred types of the grass or ventilation information according to the soil as the improvement information will be described below.

In an example shown in FIG. 6, a camera or a soil sensor is used as the condition sensor 17. In the case where the condition sensor 17 is a camera, an image of the soil generated by the camera corresponds to the condition information. The image of the soil shows the color of the soil. As described above, the soil sensor detects the moisture content or the hardness of the soil. The moisture content of the soil can be detected, for example, by measuring permittivity of the soil using a probe. That is, since the permittivity of the soil is much lower than that of water, the moisture content of the soil can be detected based on the measured permittivity. The hardness of the soil can be detected, for example, by pressing the soil with a probe and measuring the resistance force received by the probe. The measurement methods described above are disclosed just as examples and other measurement methods may be used.

In the example shown in FIG. 6, the data detected by the condition sensor 17 is used without a pro-processing. The countermeasure database in the example shown in FIG. 6 is a database where the soil information, the preferred types of the grass, and the ventilation information linked to each other are stored. The preferred types of the grass are types of the grass that are adapted to the soil and planting the grass of that type on the lawn allows the grass to grow or be maintained well. The ventilation information is information that indicates whether or not the dethatching or the aeration described above is needed.

The soil information described above relates to the preferred types of the grass. For example, different soils may be preferred for the grasses of the different types. For example, the color of the soil may be different when earth or sand that composes the soil contents different ingredients. Therefore, the characteristics of the soil, for example, drainage performance, can be inferred based on the color of the soil. In addition, the moisture content and the hardness of the soil are closely related to the characteristics of the soil. It is also known to the public that there are various types of the grass and there are soils suitable for growing the grass. Therefore, by referring to and extracting necessary information from literatures of the like, the correspondence between the soil information and the preferred types of the grass can be obtained.

The soil information described above is also closely related to the ventilation information. For example, if the soil is too hard, the lawn thatch may be accumulated and the dethatching may be required. Furthermore, if the soil is too hard, the aeration performance is likely to be low and the aeration may be required. In addition, if there is too much lawn thatch, the drainage performance is prone to be low and the moisture content of the soil is prone to be kept high. Therefore, the dethatching may be required. As described above, there is a correlation between the soil information and the ventilation information. Therefore, by obtaining sample data of the soil in various condition and analyzing the relationship between the soil information and the need for the ventilation measures, the correspondence between the soil information and the ventilation information can be obtained. Based on the above-mentioned two correspondences, the countermeasure database where the soil information, the preferred types of the grass, and the ventilation information linked to each other are stored can be built. The countermeasure database is preliminarily built and stored on the server 30 or the like.

The processor 31 can identify the preferred type of the grass and the ventilation information according to the soil information by comparing the soil information to the countermeasure database. The processor 31 outputs the information about the preferred type of the grass and the ventilation information according to the soil information as the improvement information.

With respect to the example shown in FIG. 6, FIG. 6 shows multiple condition sensor 17, multiple pieces of the condition information, and multiple pieces of the improvement information. However, at least one of the condition sensors 17 may be omitted, at least one piece of the condition information may be omitted, and at least one piece of the improvement information may be omitted. Another condition sensor 17, another piece of the condition information, or another piece of the improvement information not shown in FIG. 6 may be employed.

In the above description, the condition sensors 17, the condition information, the pro-processing, the countermeasure database, and the improvement information have been described with reference to FIG. 3 through FIG. 6, but these description are disclosed just as examples. Therefore, information not shown in FIG. 3 through FIG. 6 may be employed.

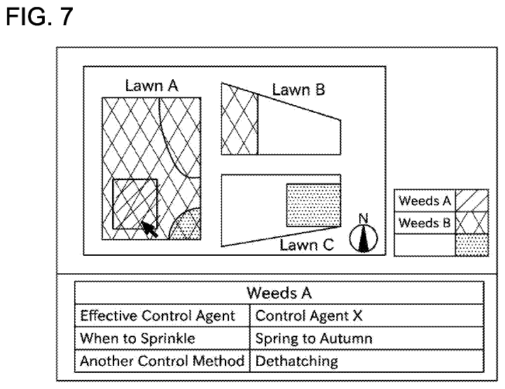

Next, with reference to FIG. 7, an example of presentation of the improvement information will be described below.

FIG. 7 shows an example of the presentation of the improvement information shown on the display of the owner terminal 40 or the contractor terminal 50. The display shows schematic views of a lawn A, a lawn B, and a lawn C. In the present embodiment, since the condition information is obtained for each position in the lawn, the weeds information can be identified for each position in the lawn. The weeds information for each position in the lawn is shown superimposed on the schematic view of the lawn. This allows the user to easily identify the weeds information for each position in the lawn.

Additionally, the control information for each weed is shown at the bottom of the display. This allows the user to easily understand what control measures should be taken for each position in the lawn.

In the present specification, the presentation method of the improvement information is described using the weeds information and the control information of the weeds as examples. However, similar presentation method as in FIG. 7 may be used to present the improvement information to the user with respect to other information than the weeds information and the control information thereof. The owner or the contractor can perform maintenance based on the improvement information that is presented to them. The contractor may also select fertilizer, control agent, soil conditioner, grass seeds, or the like based on the improvement information presented and deliver it to the owner. The contractor may also select control agent based on the improvement information presented and sprinkle the control agent using a self-propelled sprayer or the like. The control agent may also be sprinkled manually or by using the water sprinkler 21, not limited to by the self-propelled sprayer.

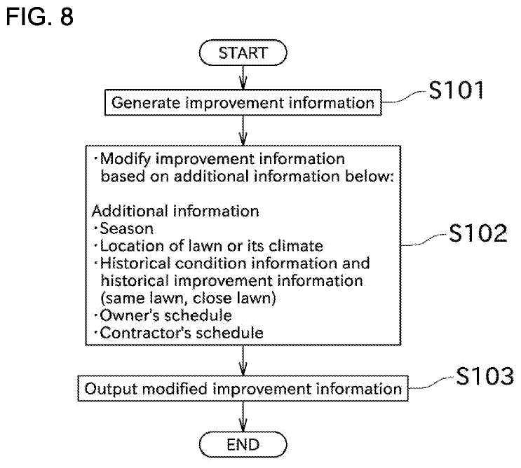

With reference to FIG. 8, a process of modifying the improvement information based on additional information will be described below.

The additional information is information that is used accessorily with respect to the condition information and used as an aid for generating the improvement information based on the condition information. By using the additional information accessorily in addition to the condition information, the processor 31 can generate more appropriate improvement information.

The processor 31 generates the improvement information as describe above (S101), then modifies the improvement information based on the additional information (S102), and outputs the modified improvement information (S103). Instead of generating the improvement information first and modifying it, the processor 31 may generate the improvement information based on both the condition information and the additional information at once. For example, more than one countermeasure database that corresponds to the additional information may be stored on the server 30, the countermeasure database that corresponds to the present additional information may be selected, and the improvement information may be generated based on the selected countermeasure database and the condition information.

The additional information may include, for example, the season, the location of the lawn or its climate, the historical condition information, the historical improvement information, the owner's schedule, or the contractor's schedule. The additional information may be detected by the lawn mower 10 and transmitted to the server 30 by the lawn mower 10, or it may be transmitted to the server 30 by the owner terminal 40 or the contract or terminal 50. Alternatively, the server 30 may detect the additional information by itself.

The season is, for example, a season that the date when the condition information is detected or the date when the improvement information is generated belongs to. Since the appropriate amount of watering or fertilizing varies with seasons, it is preferable to modify the watering information or the fertilizer information based on the present season. In addition, the appropriate control methods for the diseases, the pests, and the weeds may differ depending on the season. For example, if there is a suitable season for sprinkling a diseases, pests, or weeds control agent, it is preferable to generate the information that indicates the control agent corresponding to the present season as the improvement information. In addition, since the condition of the soil may change with the season, it is preferable to use the countermeasure database that corresponds to the present season to identify the preferred types of the grass and the ventilation information.

The climate of a region where the lawn is located can be identified based on the location of the lawn. The climate of the region itself may be used as the additional information. Since the appropriate amount of watering or fertilizing varies with climates, it is preferable to modify the watering information or the fertilizer information based on the present climate. In addition, the appropriate control methods for the diseases, the pests, and the weeds may differ depending on the climate. In addition, since the condition of the soil may change with the climate, it is preferable to use the countermeasure database that corresponds to the present climate to identify the preferred types of the grass and the ventilation information.

The historical condition information and the historical improvement information can be used as follows. The processor 31 stores the condition information detected in the past and the improvement information presented with respect to the detected condition information. In the case where the lawn mower 10 periodically mows the same lawn, the change in the condition information, i.e. whether the condition of the grass has been improved or not, can be determined. For example, if an operation based on the improvement information presented by the lawn management assistance system 1 was performed and the condition of the grass has been improved, that proves the effectiveness of the improvement information presented. Therefore, when the condition information similar to that in the past is detected, the processor 31 presents the improvement information that was presented and actually improved the condition in the past. This allows the appropriate improvement information to be presented. On the other hand, if an operation based on the improvement information presented by the lawn management assistance system 1 was performed and the condition of the grass has not been improved, that indicates the improvement information present is not effective. Therefore, when the condition information similar to that in the past is detected, the processor 31 generates the improvement information different from the improvement information presented in the past and presents it. The process that is performed using the historical condition information and the historical improvement information may be performed only with respect to the same lawn or the lawns close to it. This is because if the locations of the lawns are significantly different, the appropriate improvement information for each lawn may differ.

When utilizing the improvement information presented in the past, following points may be considered. That is, keeping using the same type of control agent on the same lawn sometimes reduces the effectiveness of the control agent because of the target of control becomes resistant to it. Therefore, with respect to the control agent to be presented, the improvement information may be adjusted so that the control agent used in the past will not be presented successively.

The owner's schedule is, for example, a schedule for the owner performing the maintenance on the lawn. The contractor's schedule is, for example, a schedule for the contractor performing the maintenance on the lawn. The processor 31 presents when to sprinkle the control agent or the fertilizer according to the schedule for the owner or the contractor performing the maintenance on the lawn. For example, if multiple types of the control agents are identified based on the countermeasure database, the processor 31 compares the owner's or the contractor's schedule for the maintenance with the appropriate season and frequency for sprinkling each of the control agents and selects and presents the control agent suitable for the maintenance by the owner or the contractor.

The additional information may be used in the pre-processing as well as in the modification of the improvement information. For example, the information about such as the season, the location of the lawn, and its climate may be used in the pre-processing of identifying the type of the lawn disease and the lawn pest based on the image of the grass. In this case, the processor 31 in advance stores season, location, and climate in which the lawn disease and the lawn pest are likely to break out linked to the types of the lawn disease and the lawn pest. This correspondence can be obtained based on literature or data stored on the server 30. The processor 31 then performs the pre-processing based on not only the image of the grass, but also the current season, the location of the lawn to be mowed, or the current climate. For example, if multiple types of the diseases and the pests are identified based on the image of the grass, the processor 31 narrows down the types of the diseases and the pests using the additional information. In this manner, the pre-processing can be performed with even higher accuracy. The additional information may be used for other pre-processing, not limited to that of identifying the type of the lawn disease or the lawn pest.

The improvement information may be generated by combining the additional information described above, such as the season, the location of the lawn, and its climate, the soil information described above with reference to FIG. 6, and the type of the grass. The additional information may include information about air temperature, sun exposure, and distribution of the inclination angle. The air temperature may be obtained by measuring or by accessing an air temperature database. The sun exposure can be measured by a light sensor. Since all of these information is related to the growth of the grass, linking it to the grass information and storing it on the server 30 makes it possible to identify a preferred combination of conditions and a condition that contributes strongly to the growth of the grass. The condition identified as described above can be used as the improvement information.

With reference to FIG. 9, a sorting rule of the improvement information according to the user categories will be described below.

The sorting rule is a rule that the improvement information generated by the processor 31 should be sent only to users that belongs to a selected user category. As mentioned above, the user categories are divided into the owners of the lawns and the contractors who provide lawn mowing services. For example, if the maintenance of the lawn is divided up among the owner and the contractor, only a piece of the improvement information related to the maintenance for which they are responsible is transmitted to the owner or the contractor. Specifically, if the owner sets up and operates the watering controller 20 at their home, the watering information does not have to be transmitted to the contractor. Also, if the owner entirely leaves the control operation to the contactor, the control information does not have to be transmitted to the owner.

For each piece of the improvement information, the owner or the contractor sets a rule that the information should be transmitted to a destination linked to the owner, linked to the contractor, or destinations linked to both. This rule can be set, for example, by operating the owner terminal 40 or the contractor terminal 50.

Specifically, after generating the improvement information (S201), the processor 31 determines whether a sorting rule according to the user categories is set (S202). If no sorting rule is set, the processor 31 transmits the all generated improvement information to the owner and the contractor (S203).

If the sorting rule is set, the processor 31 transmits the improvement information that is linked to the owner to the owner referring to the sorting rule (S204). The processor 31 transmits the improvement information that is linked to the contactor to the contractor referring to the sorting rule (S205). In this manner, each pieces of the improvement information is transmitted to the destination linked to it according to the content of the pieces of the improvement information.

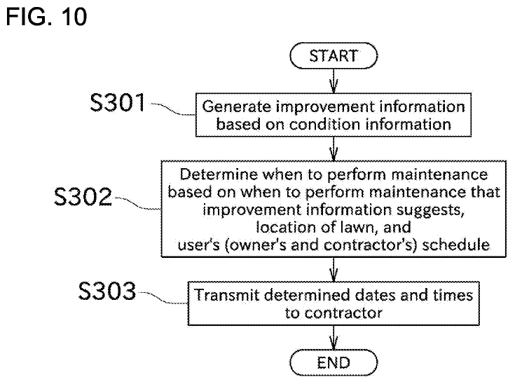

With reference to FIG. 10, a process of presenting when to perform the maintenance on more than one lawn will be described below. The process shown in FIG. 10 is mainly for the contractors. However, it can also be applied to the owner who own multiple lawns and performs the maintenance on them by themselves.

As described above, the improvement information includes suggestions related to the maintenance. For example, suggestions for the watering, the fertilizing, the control on the diseases, the pests, or the weeds, the dethatching, or the aeration are the suggestions related to the maintenance. They may be a preferred season for each maintenance. In addition, because the contractor receives requests from multiple owners, there are many lawns for the contractor to perform the maintenance. Furthermore, the owner's or the contractor's schedule should be taken into account to perform the maintenance on each lawn at the appropriate date and time. In the present embodiment, these pieces of information are organized and an appropriate order of the maintenance on each lawn is presented.

Specifically, the processor 31 generates the improvement information based on the condition information (S301). The improvement information generated in step S301 shall include suggestions for the maintenance on more than one lawn.

Then the processor 31 determines when to perform the maintenance based on when to perform the maintenance that the improvement information suggests, the location of the lawn, the owner's schedule, and the contractor's schedule (S302). For example, the processor 31 identifies a date and time that corresponds to when to perform the maintenance that the improvement information suggests and is convenient for the owner and the contractor. Then, the processor 31 determines the dates and times of the maintenance in such a manner that the dates and times for the contractor to operate overlap as little as possible. The same operation date may be identified for the maintenance on multiple lawns that are located close to each other. In this manner, the processor 31 determines all the dates and times of the maintenance on the multiple lawns. If there are not enough convenient dates and times for the owner and the contractor, the processor 31 outputs an error suggesting the same.

The processor 31 transmits the determined dates and times of the maintenance to the contractor (S303). Since the configuration described above automates schedule creation, the contractor's time and effort can be reduced.

The processor 31 may identify the order of the maintenance instead of identifying the dates and times of the maintenance. For example, the processor 31 may set an order giving priority to the maintenance that the suitable season to perform will end in the near future and postponing the maintenance that the suitable season to perform has not come or that the suitable season will not end until a long period of time passes.

In the present embodiment, the processor 31 identifies the dates and times to perform the maintenance based on three factors: when to perform the maintenance that the improvement information suggests, the location of the lawn, and the users' schedule. Alternatively, the processor 31 may identify the dates and times to perform the maintenance based on at least one of these three.

(Feature 1) As described above, the lawn management assistance system 1 of the present embodiment includes the communicator 32 and the processor 31. The communicator 32 receives the positional information of the lawn mower 10 detected by the position sensor 16 installed at the lawn mower 10 and receives the condition information of the lawn detected by the condition sensor 17 installed at the lawn mower 10. The processor 31 analyzes the condition information per piece of the positional information based on the information received by the communicator 32 and generates and outputs the improvement information indicating the method for improvement of the condition of the lawn per piece of the positional information.

Since both the position sensor 16 and the condition sensor 17 are installed at the lawn mower 10, the condition of each position of the lawn can be detected simply by driving the lawn mower 10. Therefore, a method of improving the condition of the lawn at each position of the lawn can be presented to the user of the system.

(Feature 2) In the lawn management assistance system 1 of the present embodiment, the processor 31 accesses the countermeasure database where the condition of the lawn and the coping method according to the condition of the lawn linked to each other are stored. The processor 31 generates and outputs the improvement information based on the results of the analysis of the condition information per piece of the positional information and based on the countermeasure database.

By using the countermeasure database, an appropriate coping method can be presented to the user as the improvement information.

(Feature 3) In the lawn management assistance system 1 of the present embodiment, the condition sensor 17 detects the condition of the soil, the grass, or the weeds in the lawn. The processor 31 outputs the required operation or the required substance as the improvement information with respect to the soil, the grass, or the weeds in the lawn.

This allows the required operation or the required substance to be presented to the user with respect to the soil, the grass, or the weeds in the lawn.

(Feature 4) In the lawn management assistance system 1 of the present embodiment, the improvement information includes the type or the amount of the substance required to be sprinkled in the operation with respect to the soil, the grass, or the weeds in the lawn.

This allows the type or the amount of the substance required to be sprinkled in the operation with respect to the soil, the grass, or the weeds in the lawn to be presented to the user.

(Feature 5) In the lawn management assistance system 1 of the present embodiment, the processor 31 analyzes the condition information to identify the type of the weeds growing on the lawn and outputs the control information according to the identified type of the weeds as the improvement information.

This allows the control information for the weeds present in the lawn to be presented to the user.

(Feature 6) In the lawn management assistance system 1 of the present embodiment, the processor 31 outputs the type or the amount of the control agent according to the identified weeds as the improvement information.

This allows the specific operation for controlling the weeds present in the lawn to be presented to the user.

(Feature 7) In the lawn management assistance system 1 of the present embodiment, the processor 31 determines the disease affecting the grass or the pest infesting the grass based on the condition information and outputs the control information according to the disease or the pest as the improvement information based on the results of the determination.

This allows the control information for the disease affecting the grass or the pest infesting the grass to be presented to the user.

(Feature 8) In the lawn management assistance system 1 of the present embodiment, the processor 31 determines the health condition of the grass based on the condition information and outputs the information appropriate for improving the health condition of the grass as the improvement information.

This allows the improvement information for improving the health condition of the grass to be presented to the user.

(Feature 9) In the lawn management assistance system 1 of the present embodiment, the processor 31 outputs the information about the type of the fertilizer suitable for the grass or the type of the grass suitable for the lawn as the improvement information based on the condition information.

This allows the type of the fertilizer suitable for the grass of the type of the grass suitable for the lawn to be presented to the user.

(Feature 10) In the lawn management assistance system 1 of the present embodiment, the processor 31 outputs the watering information or the ventilation information appropriate for the lawn or the grass as the improvement information based on the condition information.

This allows the watering information or the ventilation information appropriate for the lawn or the grass to be presented to the user.

(Feature 11) In the lawn management assistance system 1 of the present embodiment, the processor 31 generates and outputs the improvement information based on the season or the location of the lawn in addition to the condition information.

This allows the improvement information generated considering the current or upcoming weather or climate to be presented.

(Feature 12) In the lawn management assistance system 1 of the present embodiment, the processor 31 transmits the improvement information to the contractor that provides the lawn mowing service.

This allows the methods of improving the condition of the lawn for each position in the lawn to be presented to the contractor.

(Feature 13) In the lawn management assistance system 1 of the present embodiment, the processor 31 transmits the improvement information to the owner of the lawn in addition to the contractor. The improvement information transmitted by the processor 31 is different between the contractor and the owner.

By transmitting the improvement information according to the category of the users of the system, the information that matches the purpose of the user can be provided.

(Feature 14) In the lawn management assistance system 1 of the present embodiment, the processor 31 generates and outputs the order of the maintenance on multiple lawns based on at least one of the positional information, the condition information, or the request from the user with respect to the multiple lawns.

This allows the efficient order of the maintenance to be presented to the user.

(Feature 15) In the lawn management assistance system 1 of the present embodiment, the processor 31 outputs the improvement information based further on at least one of the climate of the region where the lawn is located, the schedule for the owner of the lawn, or the schedule for the contractor that provides the lawn mowing service.

Since it is based on more pieces of information, this allows the more appropriate improvement information to be presented to the user.

(Feature 16) In the lawn management assistance system 1 of the present embodiment, the processor 31 outputs the improvement information about the maintenance on the lawn based on the schedule for the maintenance on the lawn.

This allows the improvement information appropriate for the time when the maintenance is made to be presented to the user.

(Feature 17) In the lawn management assistance system 1 of the present embodiment, the processor 31 outputs the improvement information for the current operation based further on the historical condition information and the historical improvement information.

Since the historical information is used, this allows the more appropriate improvement information to be presented to the user.

(Feature 18) In the lawn management assistance system 1 of the present embodiment, the processor 31 generates and outputs the improvement information for the lawn to be treated based further on the historical condition information and the historical improvement information for another lawn that is close to the lawn to be treated.

Since the information about the close lawn is used, this allows the more appropriate information to be presented to the user.

(Feature 19) In the lawn management assistance system 1 of the present embodiment, the lawn mower 10 is autonomous. The communicator 32 receives the positional information from the position sensor 16 used by the lawn mower 10 to travel autonomously. The communicator 32 receives the condition information from the condition sensor 17 used by the lawn mower 10 to detect its surroundings when travelling autonomously.

Since the positional sensor and the condition sensor are used not only for the autonomous travel but also for generating the improvement information, this allows the effective use of the sensors that the lawn mower includes.

Features 1 to 19 described above can be combined as appropriate as long as no contradiction arises. For example, feature N (N=1, 2, . . . , 19) can be combined with at least one of features 1 to N−1 as appropriate.

While the preferred embodiment of the present application has been described above, the configurations explained above may be modified, for example, as follows.

The flowcharts shown in the above embodiment are disclosed just as examples and some processes may be omitted, the contents of some processes may be changed, or new processes may be added.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1-21. (canceled)

22. A lawn management assistance system, comprising:
a communicator receiving positional information of a lawn mower detected by a position sensor installed at the lawn mower and receiving condition information of a lawn detected by a condition sensor installed at the lawn mower; and
a processor analyzing the condition information per piece of the positional information based on information received by the communicator, the processor generating and outputting improvement information indicating a method for improvement of condition of the lawn per piece of the positional information.

23. The system according to claim 22, wherein the processor accesses a countermeasure database where condition of a lawn and a coping method according to the condition of the lawn linked to each other are stored and wherein the processor generates and outputs the improvement information based on results of analysis of the condition information per piece of the positional information and based on the countermeasure database.

24. The system according to claim 22, wherein the condition sensor detects condition of soil, grass, or weeds in the lawn, and wherein the processor outputs a required operation or a required substance as the improvement information with respect to the soil, the grass, or the weeds in the lawn.

25. The system according to claim 24, wherein the improvement information includes a type or an amount of a substance required to be sprinkled in an operation with respect to the soil, the grass, or the weeds in the lawn.

26. The system according to claim 22, wherein the processor analyzes the condition information to identify a type of weeds growing on the lawn and outputs control information according to the identified type of the weeds as the improvement information.

27. The system according to claim 26, wherein the processor outputs a type or an amount of a control agent according to the identified type of the weeds as the improvement information.

28. The system according to claim 22, wherein the processor determines a disease affecting grass or a pest infesting the grass based on the condition information and outputs control information according to the disease or the pest as the improvement information based on results of determination.

29. The system according to claim 22, wherein the processor determines health condition of grass based on the condition information and outputs information appropriate for improving the health condition of the grass as the improvement information.

30. The system according to claim 22, wherein the processor outputs information about a type of fertilizer suitable for grass or a type of grass suitable for the lawn as the improvement information based on the condition information.

31. The system according to claim 22, wherein the processor outputs watering information or ventilation information appropriate for the lawn or grass as the improvement information based on the condition information.

32. The system according to claim 22, wherein the processor generates and outputs the improvement information based on a season or a location of the lawn in addition to the condition information.

33. The system according to claim 22, wherein the processor transmits the improvement information to a contactor that provides a lawn mowing service.

34. The system according to claim 33, wherein the processor transmits the improvement information to an owner of the lawn in addition to a contractor and wherein the improvement information transmitted by the processor is different between the contractor and the owner.

35. The system according to claim 22, wherein the processor generates and outputs an order of maintenance on multiple lawns based on at least one of the positional information, the condition information, or a request from a user with respect to the multiple lawns.

36. The system according to claim 22, wherein the processor outputs the improvement information based further on at least one of a climate of a region where the lawn is located, a schedule for an owner of the lawn, or a schedule for a contractor that provides a lawn mowing service.

37. The system according to claim 22, wherein the processor outputs the improvement information about maintenance on the lawn based on a schedule for the maintenance on the lawn.

38. The system according to claim 22, wherein the processor outputs the improvement information for a current operation based further on historical condition information and historical improvement information.

39. The system according to claim 22, wherein the processor generates and outputs the improvement information for the lawn to be treated based further on historical condition information and historical improvement information for another lawn that is close to the lawn to be treated.

40. The system according to claim 22, wherein the lawn mower is autonomous, wherein the communicator receives the positional information from the position sensor that is used by the lawn mower to travel autonomously, and wherein the communicator receives the condition information from the condition sensor that is used by the lawn mower to detect its surroundings when travelling autonomously.

41. A system, comprising:
a lawn mower;
a position sensor;
a condition sensor; and
a lawn management assistance system according to claim 22.

42. A lawn management assistance method, comprising:
receiving positional information of a lawn mower detected by a position sensor installed at the lawn mower;
receiving condition information of a lawn detected by a condition sensor installed at the lawn mower; and
using a processor, analyzing the condition information per piece of the positional information and generating and outputting improvement information indicating a method for improvement of condition of the lawn per piece of the positional information.
